(19) United States
(12) Patent Application Publication
(10) Pub. No.: US 2006/0233309 A1
(43) Pub. Date: Oct. 19, 2006

(54) Laser x-ray source apparatus and target used therefore

(76) Inventors: Joerg Kutzner, Havixbeck (DE); Helmut Zacharias, Havixbeck (DE); Grigorios Tsilimis, Muenster (DE)

Correspondence Address: SCHNECK & SCHNECK, P.O. BOX 2-E, SAN JOSE, CA, 95109-0005, US

(21) Appl. No.: 11/106,081

(22) Filed: Apr. 14, 2005

(51) Int. Cl. H01J 35/08

(52) U.S. Cl. 378/143

(57) ABSTRACT

The invention teaches a x-ray source apparatus (50) with a continuous target (10). The continuous target (10) is hit on a first side (60) of the continuous target (10) by a photon beam (30) from a photon source (20). X-rays (80) are emitted from the continuous target (10). The emitted x-rays (80) are extracted from the x-ray source apparatus (50) from a second side (70) of the continuous target (10). The first side (60) of the continuous target (10) and the second side (70) of the continuous target (10) are opposite sides of the continuous target (10). The used continuous target (10) comprises nano particles.

### FIELD OF THE INVENTION

This invention relates to an apparatus and a method for emitting x-rays, and in particular to an apparatus for generating pulsed x-ray emission by creation of hot electrons in a continuous target.

### BACKGROUND OF THE INVENTION

X-rays are used for various analytical techniques, e.g. for x-ray photoelectron spectroscopy, electron spectroscopy for chemical analysis, and extended x-ray absorption fine structure. Intensive pulsed x-rays with high brilliance of the x-ray source, and high pulse repetition rate are necessary for some applications.

Focusing of x-rays to achieve beam cross-sections in the micrometer range enables space resolved techniques for micro structures. Pulsed x-ray sources enable time resolved measurements. The time resolution is given by the pulse duration of the x-ray source. Higher pulse repetition rates enable a faster data acquisition. X-ray sources with high repetition rates can enhance the x-ray photon flux. Higher x-ray pulse repetition rates may also enable measurements of complete processes with an improved time resolution of the process. The combination of improvements in time resolution, for a single data acquisition and for the complete process, and space resolution enables time resolved measurements of processes on a micrometer and nanometer scale.

The current state of the art x-ray source for high end analytical applications, as described above, is a synchrotron. X-ray generation by synchrotron is currently the preferred technique to produce high brilliance x-rays for analytical measurements. The problem with synchrotrons is that they are bulky, not portable, and the pulse duration is usually limited to several 10 picoseconds.

Compact x-ray source apparatuses are known as well. However, there is a need for the improvement of such compact x-ray source apparatuses. Measurements, such as those described above, could be performed with an improved compact x-ray source apparatus in a standard laboratory.

To achieve compact pulsed x-ray sources the following method is currently used: A pulsed laser beam hits target material in a target and creates a plasma. The interaction of the plasma with the laser beam excites the electrons and creates hot electrons. The interaction of the hot electrons with the target material yields the x-ray emission.

The target material is deteriorated by the high energy of the laser beam, usually the target material is evaporated at the position where the laser beam hits the target material. The target can be moved to cope with the problem of the deterioration of the target material and accordingly each pulse of the laser beam hits new target material. The movement can be achieved by rotating targets, wire targets or by so-called band targets.

U.S. Pat. No. 5,151,928 describes a x-ray source with a band target. The '928 patent describes a method and an apparatus for generating x-rays by laser impingement on a target in a vacuum enclosure to generate a plasma. The band target comprises a first film made of a suitable metal and a second film made of an x-ray transmitting material. The second film is superimposed on one surface of the first metal film, and a space A is formed between opposite parts of the first and the second film. A laser beam is projected onto the metal film so that plasma is generated by laser pulses and confined in the space between the first and the second film to increase the efficiency of x-ray generation.

The '928 patent teaches a transmission geometry in which the laser beam hits the first film on a first side, and the x-ray emission is extracted from the x-ray source apparatus from a second, opposite side. The patent describes the problem that the pressure of the highdensity plasma generated in the space A by the laser impingement causes a hole to be formed in the second film. The particles, so called debris, of the plasma pass through the hole and are likely to fly as far as the x-ray optics. The patent describes a high speed shutter system to solve this problem. Other solutions described in the patent are to optimize the pulse length or to modify the band target by addition of a third film.

The efficiency of x-ray generation by the method and the apparatus taught by the '928 patent is restricted by the limitations in generating the plasma, e.g., the thickness of the first metal film. Limitations posed on the x-ray source apparatus by the aim to prevent particle emission on the x-ray optics further restrict efficiency. The x-ray intensity is increased by extension of the interaction time of the laser and the generated plasma. Therefore, the time for each single x-ray pulse is increased and thus the time resolution for measurements is reduced.

U.S. patent application publication No. US-A-2002/0 141 536 introduces liquid droplets as a “moving” target to enable an efficient source for radiation in the extreme ultra violet (EUV) and x-ray wavelength regions. The '536 application describes a method in which liquid droplet targets are irradiated by a high power laser and are plasmarized to form a point source for EUV and x-ray emission. The described liquid droplet targets include metallic solutions and solutions of nano particles of different types of metals and non-metal materials. No damaging debris is emitted from the particle solution, according to the '536 application. The use of nano particles as an efficient droplet point source is taught in the '536 application as a preferred embodiment.

By adjusting the size of the droplet, the size of the x-ray source can be adjusted and thus the brilliance of the x-ray source can be influenced. It is difficult to achieve a constant drop rate and droplet size. However, for precise time and space resolved measurements it is essential to maintain a constant drop rate as well as droplet size.

U.S. patent application publication No. US-A-2002/0 094 063 describes a laser plasma source apparatus and target for the generation of extreme ultra violet (EUV) light. The '063 application combines the utilisation of nano particles and a band target. The '063 application teaches the generation of an electromagnetic wave in the EUV area by the use of a repeatedly irradiating laser beam. The described laser plasma EUV light source apparatus comprises a vacuum chamber, a target disposed in the vacuum chamber, an input optical system for directing the beam to the target, an output optical system for extraction of EUV light emission, a shield device for protecting the input optical system and the output optical system from debris. The generation of the debris can be restricted, and generated debris is shielded in the '063 application by the shield device.

The '063 application teaches the use of a band target comprising a polymer film with a thickness of 10 μm to 100 μm and a target material. The target material of the band target can be contained in the film or laminated on a surface of the polymer film. The '063 application teaches the use of metals or metal alloys as target materials, preferably those formed from the metals aluminium, copper, tin or silicon. The particle size is chosen to be in the range of 0.1 μm to 80 μm for the length of the particles and 5 to 10 μm thickness of the particles. The lower limits of the size ranges are determined by decreasing efficiency of the EUV light generation. The upper limits of the size ranges are determined by an increasing amount of emitted debris. The reason to use particles in the '063 application is to reduce the debris formation.

The '063 application does not teach the generation of x-rays. The size of the particles in the '063 application is mainly determined by the desire to suppress debris emission. The '063 application does not teach a transmission geometry which could enable a debris reduction on its own. The transmission geometry is not applicable to the invention of the '063 application because the polymer films are not transparent in the EUV wavelength regime.

### SUMMARY OF THE INVENTION

It is therefore an object of the invention to provide a compact x-ray source apparatus.

It is a further object of the invention to provide a x-ray source apparatus with an efficient generation of x-ray emission.

It is a further object of the invention to provide a x-ray source apparatus with a high brilliance.

It is a further object of the invention to provide a x-ray source apparatus with a high pulse repetition rate and/or a short pulse length.

It is a further object of the invention to provide a x-ray source apparatus with a reduced debris emission.

It is a further object of the invention to provide a x-ray source apparatus with a reduced jitter for pump probe experiments.

It is a further object of the invention to provide a x-ray source apparatus with a short distance between a place at which the x-rays are emitted and a sample and/or a x-ray optics.

These and other objects are solved by providing a x-ray source apparatus with a continuous target. The continuous target is hit on a first side of the continuous target by a photon beam from a photon source. X-rays are emitted from the continuous target. The emitted x-rays are extracted from the x-ray source apparatus from a second side of the continuous target. The first side of the continuous target and the second side of the continuous target are opposite sides of the continuous target. The used continuous target comprises nano particles.

In this context, continuous target means any target which can be moved with respect to the photon beam. Thus, the photon beam will not forever hit the same part of the continuous target.

The x-ray source apparatus with the continuous target can be realized as an item of laboratory equipment. The use of nano particles increases the efficiency of the x-ray source apparatus.

The transmission geometry which is employed, whereby the continuous target is irradiated from one side and the x-rays which are emitted on the other side of the continuous target are used, reduces debris emission in the used direction of the x-ray emission.

The transmission geometry enables a close distance between a sample and a place at which the x-rays are emitted. Thereby a large solid angle of the x-ray emission can be used.

The transmission geometry reduces jitter in pump probe experiments. Pump probe experiments are generally experiments in which a first part of a photon beam is used to irradiate a sample and a second part of the same photon beam is used to detect changes caused by the irradiation. Time variations between the pulse run time of photon pulses of the first part of the beam and photon pulses of the second part of the beam are called jitter. In the context of this invention the second part of the photon beam is not used directly. The second part of the photon beam is used to generate x-rays. The generated x-rays are used to detect changes caused by the first part of the photon beam. The length of a path comprising the distance from the photon source to the continuous target and the distance from the continuous target to the sample is not substantially changed by vibrations of the continuous target. On the other hand in the so called reflection geometry the length of the path comprising the distance from the photon source to the continuous target and the distance from the continuous target to the sample can be changed by vibrations of the continuous target. The variation of the length of the path creates jitter.

A laser can be used as photon source and the photon beam can be focused on a small spot on the continuous target. Thereby a high radiance of the x-rays can be achieved. The laser as photon source can be pulsed with short pulses yielding also short x-ray pulses.

The objects of the invention are further solved by using a continuous target which comprises oxide nano particles and which generates x-rays after photon irradiation. In a preferred embodiment of the invention, the oxide nano particles are metal oxide nano particles.

The oxide nano particles can be shaped in a way to enhance electron emission and plasma generation. In a preferred embodiment of the invention the oxide nano particles are needle shaped. The spikes of the needle-shaped particles can enhance the electron emission by deforming the electrical field at the spikes.

In a further preferred embodiment of the invention, the continuous target comprises at least a first layer and a second layer, whereby the first layer is a support layer. The second layer comprises the oxide nano particles and, on the photon irradiation, x-rays are emitted from the second layer.

The support layer can be manufactured independently from the second layer. Therefore, the mechanical properties of the support layer can be improved independently from the properties to generate free electrons of the second layer. Thereby the efficiency of the continuous target for x-ray generation can be improved.

The continuous target can have at least the first layer, a third layer and a fourth layer. The third layer comprises the oxide nano particles and, on the photon irradiation, hot electrons can be generated in the third layer. X-rays are emitted from the fourth layer.

The third and fourth layers enable a separate improvement of the plasma generation and the x-ray generation which allows an improved overall process.

### BRIEF DESCRIPTION OF THE DRAWINGS

FIG. 1 shows schematically a x-ray source apparatus according to the invention.

FIG. 2 shows diagrams with experimental results of focusing experiments.

FIG. 3a shows a measured spectrum of generated x-rays.

FIG. 3b shows a comparison of x-ray spectra generated according to the invention and generated conventionally is depicted.

FIG. 4a shows a two layered band target.

FIG. 4b shows a three layered band target.

### BEST MODE FOR CARRYING OUT THE INVENTION

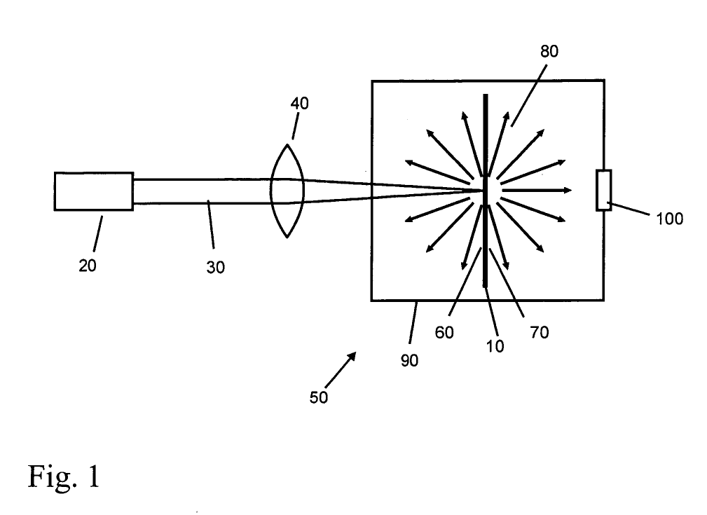

FIG. 1 shows schematically a x-ray source apparatus 50 according to one embodiment of the invention. A photon source, such as a laser, 20 generates a photon beam 30, such as a laser beam. The laser 20 used in one embodiment of the invention is a Ti:sapphire laser, but the invention is not limited to said lasers. The laser 20 can be operated in pulsed mode with pulse rates higher than 1 kHz, pulse lengths as small as 25 fs and pulse energies in the sub milli-joule to 1 mJ range, e.g. a FEMTOSOURCE PRO/OMEGA 1000 Femtolasers can be used. The photon beam 30 is focused by a first optical system 40. The first optical system 40 is a quartz lens with a focal length of 200 mm. With the first optical system 40 the photon beam 30 can be focused to an intensity in a range of 5×10¹⁴ to 5×10¹⁵ W/cm².

A continuous target 10 is placed in the focus point of the first optic 40. In this embodiment of the invention, the continuous target 10 is made of a band or a tape. The continuous target 10 comprises nano particles, preferably it comprises metal oxide nano particles 350 such as chromium oxide nano particles with a length of 500 nm and a diameter of 50 nm. The preferred embodiments of the continuous target 10 will be described in more detail below.

The laser beam 30 is focused on a first side 60 of the continuous target 10. The energy of the focused laser beam 30 creates a plasma at the position at which the focused laser beam 30 hits the band target 10. The interaction of the plasma with the laser beam 30 excites the electrons in the plasma and creates hot electrons. The interaction of the hot electrons with the material of the continuous target 10, in particular with the chromium oxide nano particles 350, yields emitted x-rays 80. Characteristic x-ray emission 80 of the chromium metal in the nano particles and bremsstrahlung continuum x-ray emission 80 is generated by this process. A part of the x-ray emission 80, which has photon energies exceeding approximately 1 keV, passes through a carrier layer 320. The chromium oxide nano particles 350 are preferably shaped in a way to enhance the process of generating the plasma. The x-rays 80 are emitted in a “reflection geometry” on the first side 60 of the band target 10 and in a “transmission geometry” on a second side 70 of the band target 10.

The continuous target 10 may be moved in a way such that two consecutive pulses from the laser 10 hit two different spots on the continuous target 10. The movement of the continuous target 10 can be realized by a spooling system (not shown) in which one end of the continuous target 10 is taken up by a first spool whilst further continuous target 10 is provided from a second spool. The speed of the continuous target 10 is in a range of 1.5 cm/s to 20 cm/s. Other forms of continuous target 10, such as movable sheets, are conceivable.

The continuous target 10 may be moved in a way such that two consecutive pulses from the laser 10 hit two overlapping spots on the continuous target 10. It can be advantageous that a spot is hit at least partly by the laser beam of a following pulse. A roughening of the surface by a first pulse can enable a better incoupling or absorption of a successive pulse.

A part of the x-ray source apparatus 50 comprising at least a part of the continuous target 10 where the x-rays 80 are generated is enclosed in a vacuum chamber 90. The pressure in the vacuum chamber 90 is approximately 5×10⁻² mbar. The vacuum chamber 90 has an out-coupling window 100 for the generated x-ray emission 80. In one example of the invention the out-coupling window 100 is made of a beryllium window. The out-coupling window 100 is mounted in the transmission geometry, facing the second side 70 of the band target 10. The transmission geometry reduces debris hitting the out-coupling window 100. In the transmission geometry the reflected parts of the laser beam 30 (i.e., the reflection geometry described above) are not reflected to the out-coupling window 100.

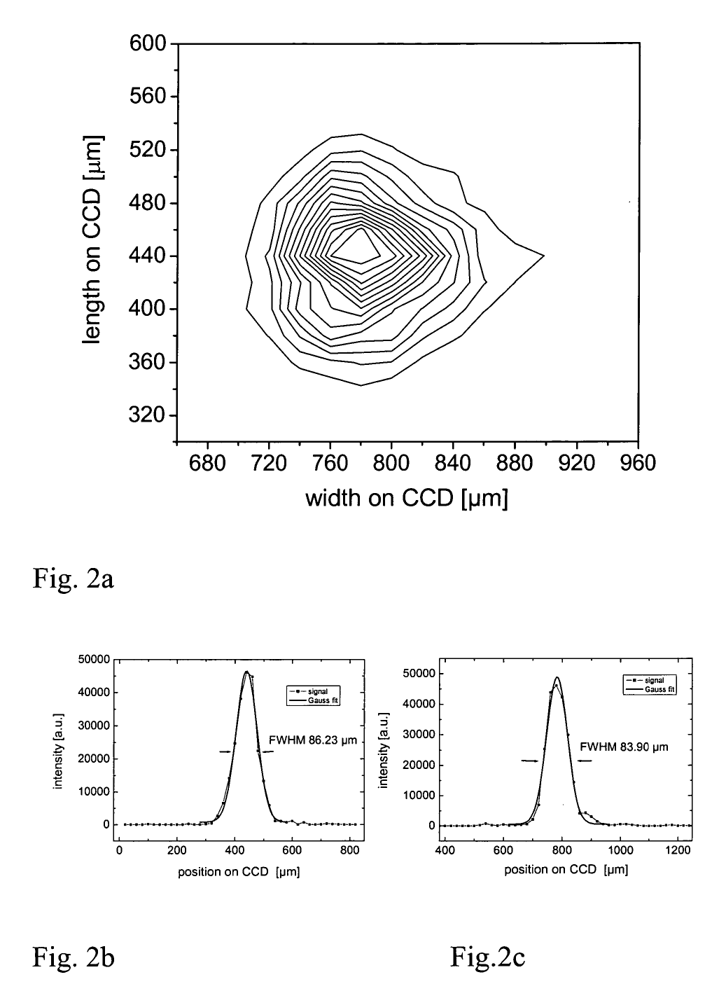

In FIG. 2, experimental results of focusing experiments are shown. The x-rays 80 have been monochromatized and focused by a toroidally bent single crystal monochromator. The continuous target 10 with chromium oxide nano particles 10 has been irradiated with the Ti:sapphire laser 20 with laser pulses with a pulse length of 30 fs and a pulse energy of 400 μJ. A photon stream of approximately 800 monochromatic CrKₐ photons per second has been achieved behind the monochromator. Focusing experiments have been conducted with the x-ray emission 80 which has been extracted from the x-ray source apparatus 50. In FIG. 2, the smallest beam diameter which has been achieved is shown. The measurements show a substantially symmetrical round beam cross section at the focus position with a full width at half maximum of approximately 86 μm in horizontal direction and a full width at half maximum of approximately 84 μm in vertical direction. The minimum beam diameter at the focus position is essential for space resolved measurements. A highly focusable x-ray beam, yielding a small beam diameter at the focus position, provides a high x-ray 80 photon density in the application region. The space resolution in experiments can be further enhanced. The space resolved measurements, e.g. microscopy applications, can use only a part of the x-ray spot which is focused on the sample.

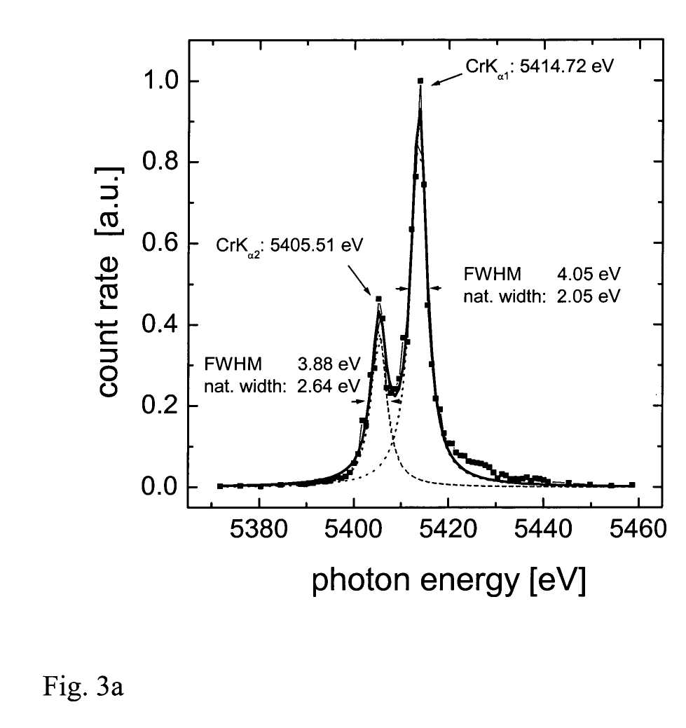

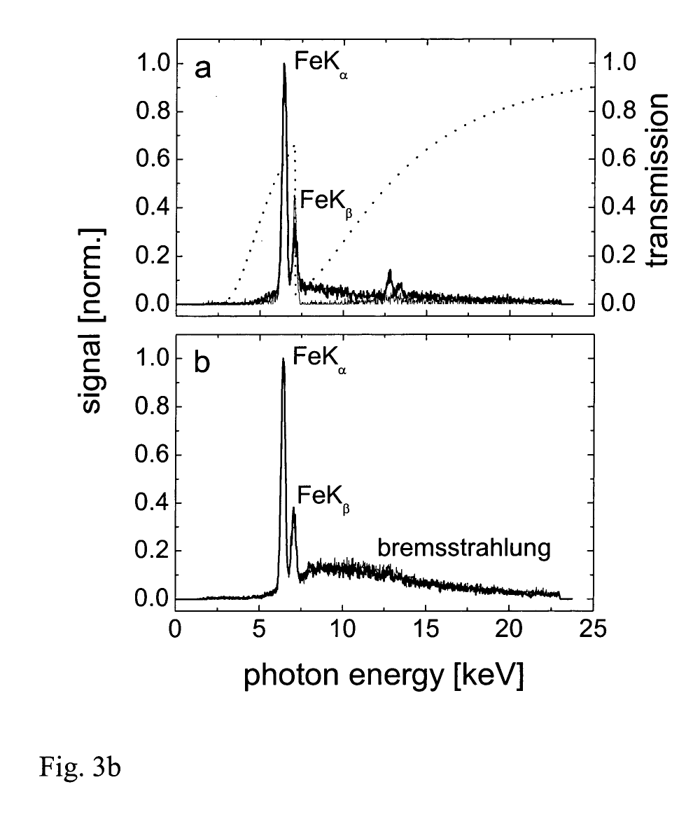

In FIG. 3, a measured spectrum of the x-rays 80, which have been generated according to the invention, is shown. The x-rays 80 have been generated with the x-ray source apparatus 50 as described above in relation to FIG. 1. The x-rays 80 have been generated using chromium oxide metal oxide nano particles 350. The spectrum shows the characteristic x-ray emission of the CrKₐ₁ (at 5414.72 eV) and CrKₐ₂ (at 5405.51 eV) lines. The measured spectrum shows an increased line width for the characteristic x-ray emission. The CrKₐ₁ line is increased from a natural full width at half maximum of 2.05 eV to a measured line width of 4.05 eV. The CrKₐ₂ line is increased from a theoretical full width at half maximum of 2.64 eV to a measured line width of 3.88 eV.

A comparison of x-ray spectra which have been measured in a reflection geometry and in the transmission geometry is shown in FIG. 3b. The x-ray spectra have been generated by the x-ray source apparatus 50 according to the invention and by a conventional x-ray source apparatus with a massive metal band used as a continuous target. A 10 μm thick iron metal band has been used as the conventional target. In the diagram showing the measurements for the conventional x-ray source the absorption of the metal is depicted as well. The measured x-ray signal is normalized in the diagrams. A part of the bremsstrahlung continuum of the conventional target is strongly absorbed in the transmission geometry. However, the continuous target according to the invention shows almost no difference between the bremsstrahlung continuum in the transmission geometry and in the reflection geometry. Therefore the x-rays of the bremsstrahlung in the transmission geometry continuum can be used only with the continuous target 10 according to the invention.

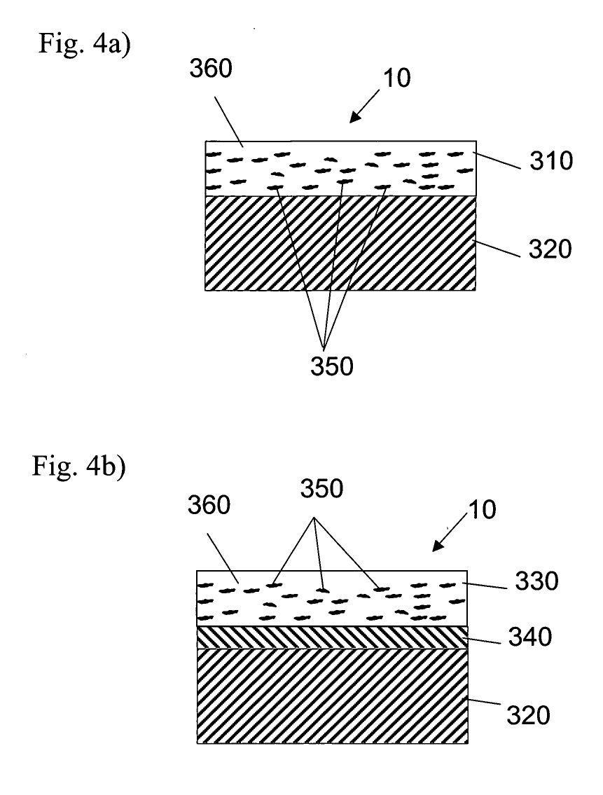

A preferred embodiment of the continuous target 10 is shown in FIG. 4a in the form of a band target. The continuous target 10 is approximately 5 mm to 10 mm broad and 17 μm thick. A first layer is a carrier layer 320. The carrier layer 320 has a thickness of about 11 μm. A suitable material for the carrier layer 320 is polyethylene terephthalate. Polyethylene terephthalate is a substantially tearproof material and thus enables a fast movement and a fast winding of the continuous target 10.

The continuous target 10 of FIG. 4a comprises a second layer 310. The second layer 310 is approximately 6 μm thick. The second layer 310 comprises nano particles 350, e.g. iron oxide and/or chromium oxide nano particles. The nano particles 350 are shaped in a substantially cylindrical manner and have a length of about 500 nm and a diameter of about 50 nm. In a further preferred embodiment, the nano particles 350 are shaped as needles whereby the two ends of the substantially cylindrical shape are tapering off. The second layer 310 further comprises a polymer film 360. The nano particles 350 are embedded in the polymer film 360 of the second layer 310.

In a preferred embodiment of the invention, the nano particles 350 have spikes. The generation of free electrons is enhanced at spikes. Sharp spikes facilitate the generation of free electrons by the electrical field of the photon beam 30. A high density of nano particles 350 can further enhance the efficiency of the emission of x-rays 80.

In a further preferred embodiment, the nano particles 350 are oriented with respect to each other. The nano particles, e.g., can all be oriented in plane of the continuous target 10 and vertical to the direction of movement of the continuous target 10. In a further embodiment, the nano particles are oriented in plane of the continuous target 10 and parallel to the direction of the movement of the continuous target 10.

FIG. 4b shows a different preferred embodiment of the continuous target 10. The continuous target 10 comprises the carrier layer 320 as the first layer. The continuous target 10 comprises a third layer 330 and a fourth layer 340 instead of the second layer 310 of the embodiment shown in FIG. 4a. The third layer 330 of the FIG. 4b comprises nano particles comparable to the second layer of FIG. 4a. The fourth layer 340 inserted between the carrier layer 320 and the third layer 330. The fourth layer 340 comprises a thin film, e.g. an iron film. The hot electrons are created, when the continuous target 10 is in use in the x-ray source apparatus 50, by a laser irradiation in the third layer 330. The x-rays 80 are emitted from the fourth layer 340. A separate optimization of the properties of the fourth layer 340, emitted x-rays 80, and the third layer 330, in which hot electrons are generated, is enabled by the separation of the fourth layer 340 and the third layer 330. The fourth layer 340 may comprise the same material as the nano particles 350 in which case x-rays 80 are emitted in the third layer 330 and in the fourth layer 340. The fourth layer 340 may comprise a different material as the nano particles 350 in which case the x-ray emission is preferably generated mainly in the fourth layer 340.

The foregoing is considered illustrative of the principles of the invention and since numerous modifications will occur to those skilled in the art, it is not intended to limit the invention to the exact construction and operation described. All suitable modifications and equivalents fall within the scope of the claims.

1. A continuous target (10) which comprises oxide nano particles (350) and which after photon irradiation emits x-rays.

2. The continuous target according to claim 1 whereby the oxides are metal oxides.

3. The continuous target (10) according to claim 1 whereby the continuous target (10) is made at least partly of a polymer.

4. The continuous target (10) according to claim 3 whereby the polymer is chosen from the group consisting of polyethylene, polyethylene terephthalate, polyimide, polypropylene and polycarbonate.

5. The continuous target (10) according to claim 1 whereby the oxides are chosen from the group consisting of nickel oxide, chromium oxide, copper oxide, iron oxide, aluminium oxide, titanium oxide, silicon oxide and molybdenum oxide.

6. The continuous target (10) according to claim 1 whereby the continuous target (10) comprises at least a first layer (320) and a second layer (310), whereby the first layer (320) is a support layer;
the second layer (310) comprises the oxide nano particles (350); and
on the photon irradiation of the continuous target (10) x-rays are emitted from the second layer (310).

7. The continuous target (10) according to claim 1 whereby
the continuous target (10) comprises at least the first layer (320), a third layer (330) and a fourth layer (340);
the third layer (330) comprises the oxide nano particles (350);
on the photon irradiation of the continuous target (10) hot electrons are generated in the third layer (330); and
on the photon irradiation of the continuous target (10) x-rays are emitted from the fourth layer (340).

8. The continuous target (10) according to claim 1 whereby the oxide nano particles (350) have a length of approximately 500 nm.

9. The continuous target (10) according to claim 1 whereby the oxide nano particles (350) have a diameter of approximately 50 nm.

10. The continuous target (10) according to claim 1 whereby the oxide nano particles (350) have a substantially cylindrical shape.

11. The continuous target (10) according to claim 1 whereby the oxide nano particles (350) have a substantially needle-like shape.

12. The continuous target (10) according to claim 1 whereby the oxide nano particles (350) are oriented in relation to each other.

13. A x-ray source apparatus (50) with a continuous target (10) whereby in use
a photon beam (30) from a photon source (20) hits the continuous target (10) on a first side (60) of the continuous target (10);
x-rays (80) are emitted from the continuous target (10);
the x-rays (80) extracted from the x-ray source apparatus (50) from a second side (70) of the continuous target (10); and
the first side (60) of the continuous target (10) and the second side (70) of the continuous target (10) are on opposite sides of the continuous target (10), and the continuous target (10) comprises nanoparticles.

14. The x-ray source apparatus (50) according to claim 13 whereby the continuous target (10) comprises a polymer film.

15. The x-ray source apparatus (50) according to claim 13 whereby the nano particles comprise oxides.

16. The x-ray source apparatus (50) according to claim 15 whereby the oxides are metal oxides.

17. The x-ray source apparatus (50) according to claim 13 whereby the nano particles are oriented and a polarisation direction of the laser (20) is oriented relative to the orientation of the nano particles.

18. A method of creating x-rays (80) by irradiating a continuous target (10), which comprises oxide nano particles (350), with a photon beam (30) from a photon source (40).

19. A method of producing x-rays (80) with a x-ray source apparatus (50) comprising the following steps:
irradiating a continuous target (10), which comprises nano particles, with a photon beam (30) form a photon source (20) from a first side (60) at least for a part of the time; and
extracting the x-rays (80) from the x-ray source apparatus (50) from a second side (70) which is on a opposite side of the continuous target (10) than the first side (60).

20. The method according to claim 19 whereby the continuous target (10) is irradiated with a pulsed photon beam (30).

21. The method according to claim 19 whereby the continuous target (10) is moved.
